(19) United States
(12) Patent Application Publication
(10) Pub. No.: US 2011/0265971 A1
(43) Pub. Date: Nov. 3, 2011

(54) AUXILIARY VEHICLE REST STATION

(76) Inventor: William Thaxton, Boise, ID (US)

(21) Appl. No.: 13/098,402

(22) Filed: Apr. 30, 2011

Related U.S. Application Data
(60) Provisional application No. 61/330,004, filed on Apr. 30, 2010.

(51) Int. Cl. B60H 1/00

(52) U.S. Cl. 165/41

(57) ABSTRACT

An auxiliary vehicle rest station for providing auxiliary utility services to a parked wheeled vehicle. The auxiliary vehicle rest station includes a caddy having wheels for transporting and maneuvering the device. The caddy is configured to be positionable at least partially beneath the parked wheeled vehicle. A boom is attached to and projects from the caddy to accommodate introduction of conditioned air through the boom into the vehicle. The auxiliary vehicle rest station includes an air conditioning system. The auxiliary vehicle rest station also includes a conductor for connecting the air conditioning system a power supply. Alternately, the auxiliary vehicle rest station may include a power supply system. The auxiliary vehicle rest station may also include data links for communication and entertainment systems.

### RELATED APPLICATIONS

This application claims the benefit of the filing date of a prior-filed Provisional Application Ser. No. 61/330,004 entitled Modular Vehicle Rest Station, filed Apr. 30, 2010, which is incorporated by reference herein.

### BACKGROUND OF THE INVENTION

1. Field of the Invention

The present invention relates to auxiliary power and air handling systems and more particularly to an auxiliary vehicle rest station for providing auxiliary power and air handling capabilities to trucks, particularly over-the-road or long haul vehicles whose drivers are required to observe mandatory periods of rest and down-time.

2. Background

The prior art includes a variety of auxiliary air conditioning and heating systems to be used by trucks or other vehicles, see for example U.S. Pat. No. 7,259,469 to Brummett, et al., U.S. Pat. No. 5,333,678 to Mellum, et al., and U.S. Pat. No. 4,762,170 to Nijjar, et al., all which teach auxiliary units that include a separate truck mounted auxiliary engine. Additionally, the prior art includes a variety of auxiliary air conditioning and heating systems that employs a fuel cell, see for example, U.S. Pat. No. 7,543,454 to Harris, U.S. Pat. No. 7,216,812 to Eberspach, et al., U.S. Pat. No. 7,090,043 to Liu, et al., and U.S. Pat. No. 6,454,180 to Matsunaga, et al.

While these devices may provided the advantage of serving to reduce emissions by allowing a vehicle operator to shut down the vehicles engine during rest stops, switching over to a smaller more efficient auxiliary power source, the disadvantage with each is found in the fact that the owner or operator of the vehicle would have to undertake the additional investment required to purchase and install the unit, find the space on the vehicle to accommodate the auxiliary unit and undertake the maintenance of the unit in addition to the cost and time dedicated to maintenance of the vehicle itself.

IdleAire Systems of Knoxville, Tenn. manufactured and installed a number of its IdleAire Service Delivery Modules which include a gantry mounted auxiliary heating, cooling and ventilation unit positioned above a parking space for the vehicle. A vehicle is positioned below the gantry and the gantry mounted module is connected to the vehicle by a flexible hose which also houses delivery mechanisms for a communications and entertainment packages including a computer that allows sending and receiving email, web browsing, digital telephone service, television and movies on demand. Billing for use of the module is accomplished electronically.

One disadvantage of the IdleAire System is seen primarily in its cost of implementation, due to the need to erect a gantry for positioning the modules and the requirement that real estate be dedicated solely for use of vehicles employing the system. Another disadvantage of the IdleAire System is seen in the fact that the modules are mounted at a substantial height above ground level. When repairs or maintenance are required, these must be performed either from a scaffold, a man-lift or other device that can raise and position maintenance personnel safely above ground-level.

What is needed is a system that serves to reduce emissions while an over-the-road vehicle is parked during an operator's rest or down time and which does not require additional capital expense by the vehicle owner. Benefit may also be found in providing an auxiliary heating, cooling and ventilation unit that does not require the erection of a superstructure for positioning the system above the vehicle. Additional advantage may also be found in providing an auxiliary heating, cooling and ventilation unit that does not require the dedication of parking spaces solely for users of the system only but rather offers the flexibility of allowing users as well as non-users of the system to park in any selected parking spot while having the system locatable at any parking spot. In addition advantage may be found in elimination of a superstructure or gantry and the adoption of a mobile modular auxiliary heating, cooling and ventilation unit that permits easy removal of the auxiliary system to a shop or other maintenance location wherein repair or maintenance personnel may work at ground level without interruption of the maneuvers of vehicles in the parking area, and without the need for a scaffold, man-lift or other device that can raise and position maintenance personnel safely above ground-level.

Therefore an object of the present invention is to provide an alternative system for reducing emissions when the over-the-road vehicle is parked during an operator's rest or down time and which does not require additional capital expense by the vehicle owner. Another object of the present invention is to provide an auxiliary heating, cooling and ventilation unit that does not require the erection of a superstructure for positioning the system above the vehicle. Yet another object of the present invention is to provide an auxiliary heating, cooling and ventilation unit that does not require the dedication of parking spaces solely for users of the system but rather offers the flexibility of allowing users as well as non-users of the system to park in any selected parking spot while having the system locatable at any parking spot. An additional object of the present invention is to eliminate the need for a superstructure or gantry for an auxiliary heating, cooling and ventilation unit that allows repair or maintenance at ground level.

### SUMMARY OF THE INVENTION

The present invention is directed to an auxiliary vehicle rest station that is configured so that at least a portion of the device is positionable beneath the vehicle during use providing auxiliary heating, ventilation and air conditioning services for use by over-the-road trucks or other vehicles. The auxiliary vehicle rest station may also include access to a power supply capable of powering the various sub-systems of the station including an auxiliary air conditioning system. As used herein the term “air conditioning system” refers to heating, ventilation or air conditioning or cooling systems, as well as any combinations thereof. The auxiliary vehicle rest station may also include one or more data links for communication and entertainment systems. These may include links for internet, telephone services, video rental and streaming video.

In a preferred embodiment, the auxiliary vehicle rest station is configured so that at least a portion of the device is positionable beneath the vehicle, thereby reducing the footprint of the device that lies outside a footprint of the vehicle when the device is in use. In the preferred embodiment, the auxiliary vehicle rest station is configured for wheeled transport such that the device is positioned against the vehicle once the vehicle is parked. Preferably one or more of the wheels are lockable so that the auxiliary vehicle rest station may be held in position so as to remain substantially stationary during use. Additionally, the auxiliary vehicle rest station may include drive means adapted for advancing the device to and from a location proximate to the vehicle that will utilize the device.

The auxiliary vehicle rest station also includes a boom that extends or projects from the caddy to a height of a vehicle window. As such, the auxiliary vehicle rest station may also include a boom lift adapted for raising or projecting the boom. The boom is adapted so that an upper segment of the boom is substantially sealable with a window located on a body surface of the vehicle to accommodate an efficient introduction of conditioned air to the cab of the truck.

In one embodiment of the invention the auxiliary vehicle rest station is positioned with respect to the vehicle such that a compressible boot surrounding the boom outlet forms a substantially air flow free seal about a window, and site power is connected to the auxiliary vehicle rest station to power the heating, ventilation, air conditioning systems of the auxiliary vehicle rest station to be used by the vehicle.

In another embodiment of the present invention a power supply may include one or more power storage devices, for example lithium ion batteries. The power storage devices may be charged at a separate charging station or may alternately be charged by an onboard power generation means. The onboard power generation means may include a hydrogen fuel cell. Alternately, the onboard power generation means may include a small form factor internal combustion engine with attached generation device.

### DESCRIPTION OF THE DRAWINGS

FIG. 1 is a representative side view of an auxiliary vehicle rest station according to the present invention positioned with respect to an over-the-road vehicle;

FIG. 2 is a representative side view of an auxiliary vehicle rest station according to the present invention being positioned with respect to an over-the-road vehicle;

FIG. 3 is a representative side view of an auxiliary vehicle rest station according to the present invention;

FIG. 4 is a representative top view of an auxiliary vehicle rest station according to the present invention;

FIG. 5 is a representative front view of an auxiliary vehicle rest station according to the present invention;

FIG. 6 is a representative side cutaway view of an auxiliary vehicle rest station according to the present invention;

FIG. 7 is a representative top schematic view of a caddy for an auxiliary vehicle rest station according to the present invention;

FIG. 8 is a representative top schematic view of a caddy for an auxiliary vehicle rest station according to the present invention; and

FIG. 9 is a representative top schematic view of a caddy for an auxiliary vehicle rest station according to the present invention.

### DETAILED DESCRIPTION

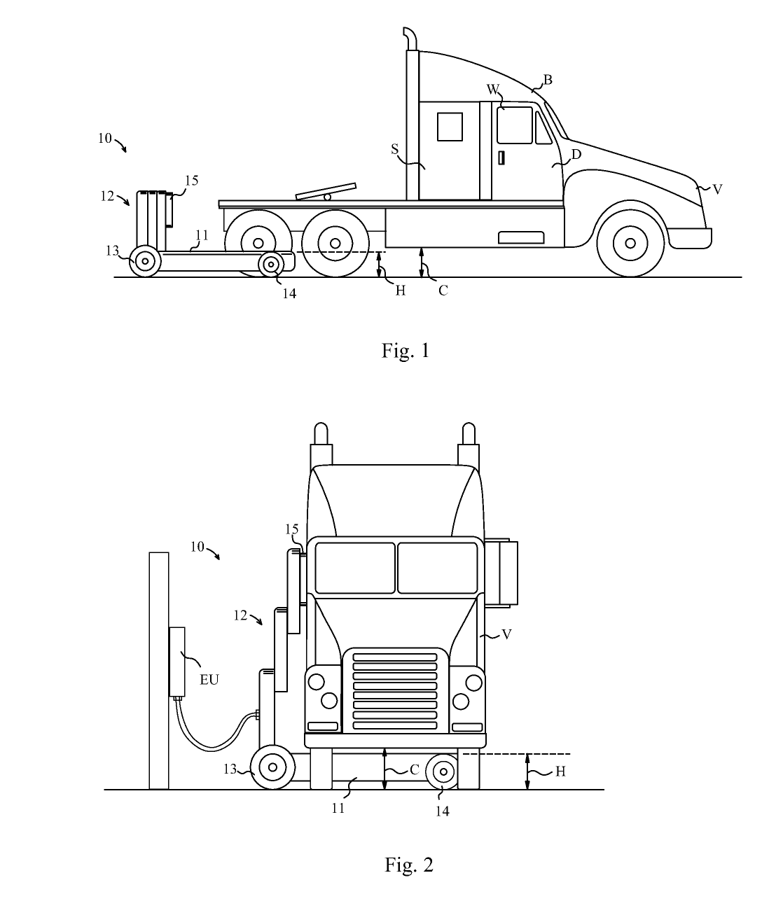

FIGS. 1 and 2 show auxiliary vehicle rest station 10 positioned in the proximity of vehicle V. As shown auxiliary vehicle rest station 10 includes caddy 11 to which boom 12 is connected. Auxiliary vehicle rest station 10 is transportable on locking rear wheels 13 and front wheels 14 which are attached to caddy 11. Caddy 11 is configured having height H that is less than ground clearance C of vehicle V, such that auxiliary vehicle rest station 10 may be positioned with respect to vehicle V such that caddy extends beneath vehicle V when in use.

As seen in FIG. 2, boom 12 projects vertically from caddy 11 such that when caddy 11 is positioned beneath vehicle V, as contemplated by the invention, boom 12 may be positioned in such close proximity to door D located on side S of vehicle V so that seal 15 attached to is boom 12 compressed against a surface of surrounding window W. Auxiliary vehicle rest station 10 is powered by connection to existing electrical utility EU.

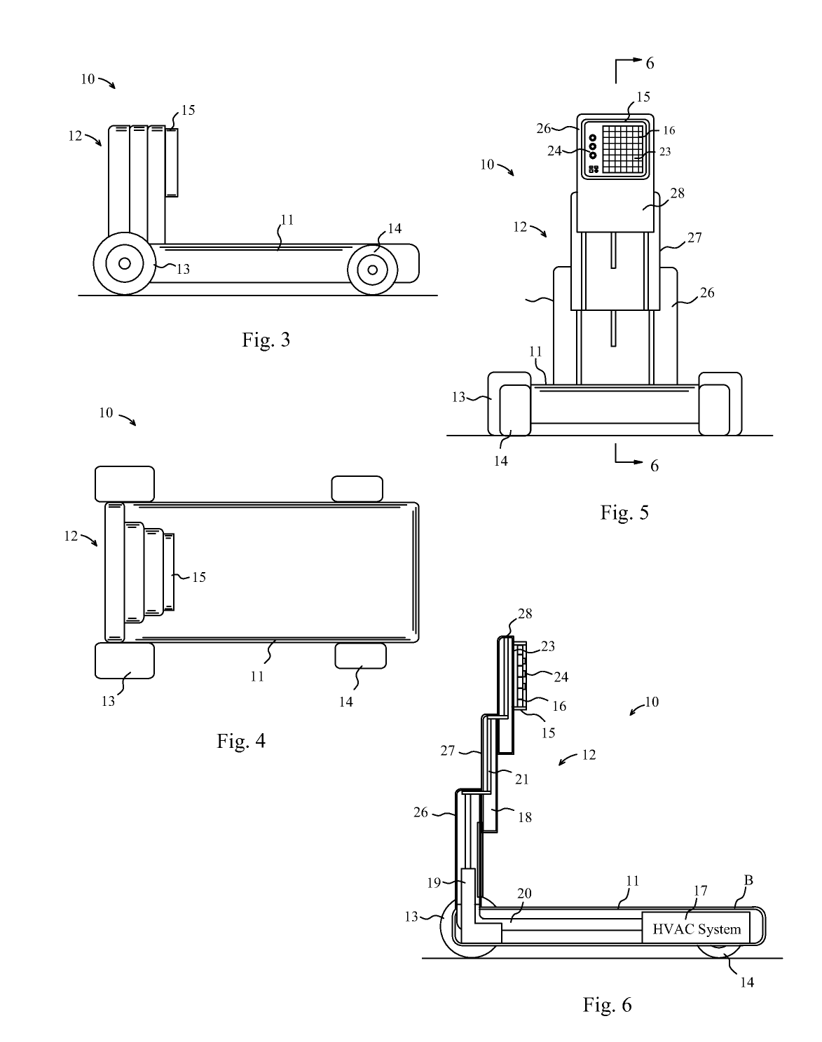

Referring to FIGS. 3 through 6, auxiliary vehicle rest station 10 is shown including caddy 11 to which boom 12 is connected. Auxiliary vehicle rest station 10 is transportable on locking rear wheels 13 and front wheels 14 which are attached to caddy 11. FIGS. 3 ad 4 show auxiliary vehicle rest station 10 wherein boom 12 is show in a retracted configuration as would be typical for transport to a location for use.

FIGS. 5 and 6 show auxiliary vehicle rest station 10 with boom 12 projecting vertically for positioning seal 15 against a vehicle (as shown in FIG. 2). As shown, boom 12 includes boom segments 26-28. FIG. 5 shows seal 15 surrounding vent aperture 16. Control panel 22 is also shown positioned within a perimeter of seal 15.

FIG. 6 is a representative side cutaway view of auxiliary vehicle rest station 10, showing Air Conditioning System 17 housed in caddy 11. Duct 20 extends from Air Conditioning System 17 to plenum 18 comprising the interior volume of boom 12. Boom 12 also includes outlet 23 located near an upper end of upper boom segment 28. FIG. 6 also shows boom lift 19 and linkage 21 for raising boom 12. As shown in FIG. 6, systems contained within caddy 11, for example Air Conditioning System 17 and boom lift 19 are positioned so these systems and their relative weights and locations within caddy 11 create ballast B for stabilizing boom 12 particularly when in the extended configuration shown in FIGS. 2, 5 and 6.

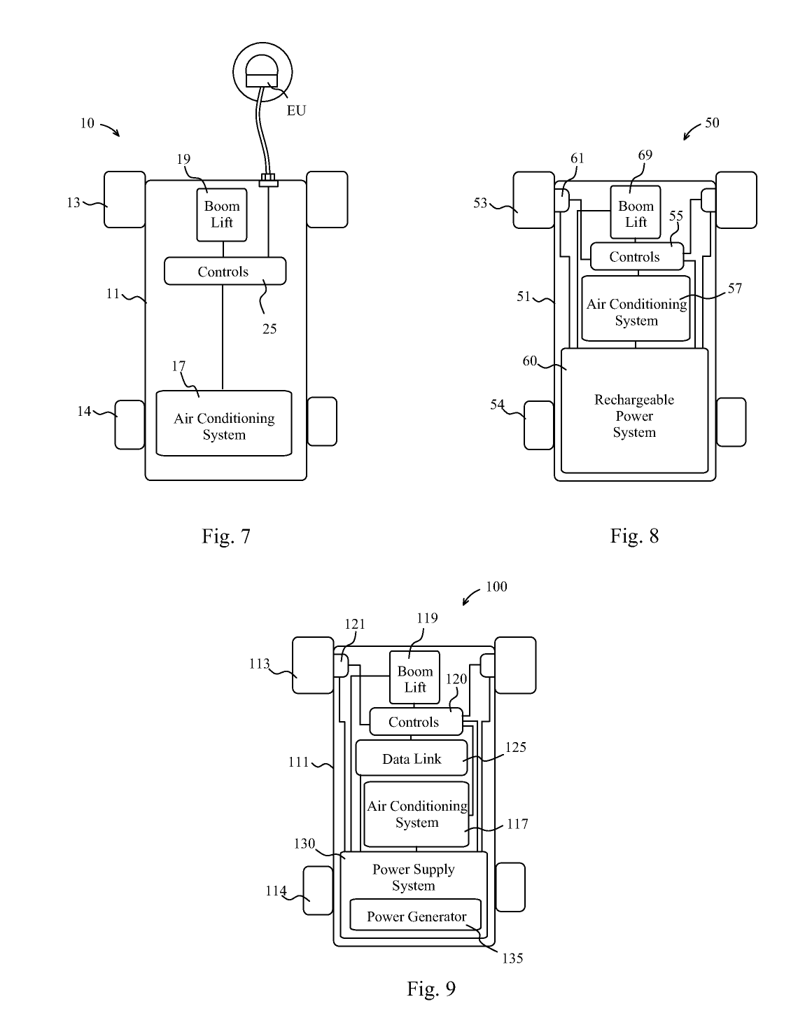

FIGS. 7 through 9 depict various configurations of auxiliary vehicle rest stations that are contemplated to be within the scope of the invention.

FIG. 7 is a representative top schematic view of auxiliary vehicle rest station 10 showing Air Conditioning System 17 housed within caddy 11. Caddy 11 is supported and is transportable and maneuverable on pairs of locking wheels 13 and 14. Air Conditioning System 17 is connected to controls 25 and powered by connection to a separate existing electrical utility EU. Similarly, boom lift 19 is shown connected to controls 25 and powered by connection to existing electrical utility EU. As shown in FIG. 7, auxiliary vehicle rest station 10 is the lightest of the configurations shown in FIGS. 7 through 9 offering ease of manual transport and maneuvering. Once positioned the power necessary for operation of onboard systems including Air Conditioning system 17 and boom lift 19 are powered by connection to an external source.

FIG. 8 is a representative top schematic view of auxiliary vehicle rest station 50 showing Air Conditioning System 57 housed within caddy 51. Caddy 51 is supported and is transportable and maneuverable on pairs of wheels 53 and wheels 54. Air Conditioning System 57, boom lift 59 and a pair of servo motors 61, one located at each of the pair of wheels 53, are each connected to controls 55 and are each powered by rechargeable power system 60. Rechargeable power system 60 of auxiliary vehicle rest station 50 is recharged by connection to an existing electrical utility.

FIG. 9 is a representative top schematic view of auxiliary vehicle rest station 100 showing Air Conditioning System 117 housed within caddy 111. Caddy 111 is supported and is transportable and maneuverable on pairs of locking wheels 113 and wheels 114. Air Conditioning System 117, boom lift 119, a pair of servo motors 121, one located at each of the pair of locking wheels 113 and data connection are each connected to controls 120 and are each powered by power supply system 130 which includes power generator 135.

While each of the above configurations shown in FIGS. 7 through 9 offer features not seen in the others, they all have in common an extensible boom and a caddy configured to be rolled beneath the vehicle which the device will be servicing.

While this invention has been described with reference to the described embodiments, this is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. An auxiliary vehicle rest station for providing auxiliary utility services to a parked wheeled vehicle, the wheeled vehicle including a ground clearance and a cab having a vehicle aperture formed in a side of the vehicle, the auxiliary vehicle rest station comprising:
a caddy including at least a pair of wheels, the caddy portion configured so as to be at least partially positionable beneath the parked wheeled vehicle; and
a boom attached to and projectable from the caddy, the boom including a plenum having an outlet adapted for introduction of conditioned air to the cab of the vehicle.

2. The auxiliary vehicle rest station of claim 1 further comprising an air conditioning system at least partially enclosed within the caddy.

3. The auxiliary vehicle rest station of claim 1 further comprising:
an air conditioning system at least partially enclosed within the caddy; and
means for connecting the caddy to a power supply.

4. The auxiliary vehicle rest station of claim 1 further comprising:
an air conditioning system at least partially enclosed within the caddy; and
a power supply system at least partially enclosed within in the caddy, the air conditioning system connected to the power supply system.

5. The auxiliary vehicle rest station of claim 1 further comprising a data link.

6. The auxiliary vehicle rest station of claim 1 further comprising a boom lift at least partially enclosed within the caddy, the boom lift adapted to extend the boom.

7. The auxiliary vehicle rest station of claim 1 wherein the boom further comprises at least two boom segments, a first of the at least two boom segments extendable with respect to a second of the at least two boom segments.

8. The auxiliary vehicle rest station of claim 1 wherein the boom further comprises a compressible seal attached about the outlet, the compressible seal configured to form a substantially air flow free seal against the side of the vehicle.

9. An auxiliary vehicle rest station for providing auxiliary utility services to a parked wheeled vehicle, the wheeled vehicle including a ground clearance and a cab having a vehicle aperture formed in a side of the vehicle, the auxiliary vehicle rest station comprising:
a caddy including at least a pair of wheels, the caddy portion configured so as to be at least partially positionable beneath the parked wheeled vehicle;
an air conditioning system at least partially enclosed within the caddy; and
a boom attached to and projectable from the caddy, the boom including a plenum having an outlet adapted for introduction of conditioned air to the cab of the vehicle.

10. The auxiliary vehicle rest station of claim 9 further comprising means for connecting the air conditioning system to a power supply.

11. The auxiliary vehicle rest station of claim 9 further comprising a power supply system at least partially enclosed within the caddy, the air conditioning system connected to the power supply system.

12. The auxiliary vehicle rest station of claim 9 further comprising a data link.

13. The auxiliary vehicle rest station of claim 9 further comprising a boom lift at least partially enclosed within the caddy, the boom lift adapted to extend the boom.

14. The auxiliary vehicle rest station of claim 9 wherein the boom further comprises at least two boom segments, a first of the at least two boom segments extendable with respect to a second of the at least two boom segments.

15. The auxiliary vehicle rest station of claim 9 wherein the boom further comprises a compressible seal attached about the outlet, the compressible seal configured to form a substantially air flow free seal against the side of the vehicle.

16. An auxiliary vehicle rest station for providing auxiliary utility services to a parked wheeled vehicle, the wheeled vehicle including a ground clearance and a cab having a vehicle aperture formed in a side of the vehicle, the auxiliary vehicle rest station comprising:
a caddy including at least a pair of wheels, the caddy portion configured so as to be at least partially positionable beneath the parked wheeled vehicle;
an air conditioning system at least partially enclosed within the caddy;
means for connecting the air conditioning system to a power supply; and
a boom attached to and projectable from the caddy, the boom including a plenum having an outlet adapted for introduction of conditioned air to the cab of the vehicle.

17. The auxiliary vehicle rest station of claim 16 further comprising a power supply system at least partially enclosed within the caddy, the air conditioning system connected to the power supply system.

18. The auxiliary vehicle rest station of claim 16 further comprising a data link.

19. The auxiliary vehicle rest station of claim 16 further comprising:
the boom including at least two boom segments, a first of the at least two boom segments extendable with respect to a second of the at least two boom segments; and
a boom lift at least partially enclosed within the caddy the caddy, the boom lift adapted to extend the boom.
